(19) United States
(12) Patent Application Publication
(10) Pub. No.: US 2011/0099044 A1
(43) Pub. Date: Apr. 28, 2011

(54) Methods and Apparatus for Promotional Display of Images of Products Presented for Entry Into Purchase Transactions

(75) Inventor: Brian A. Mediano, Cebu (PH)

(73) Assignee: NCR Corporation, Dayton, OH (US)

(21) Appl. No.: 12/606,612

(22) Filed: Oct. 27, 2009

(51) Int. Cl. G06Q 30/00; G06Q 10/00

(52) U.S. Cl. 705/7.29; 705/14.46; 705/14.38

(57) ABSTRACT

Systems and techniques for managing promotional displays, including images of products being presented for entry into transactions. As each product is presented, an analysis is performed of promotional information relating to the product to determine the eligibility of the product for promotional display and to determine parameters governing such a promotional display. Promotional displays of one or more products are presented based on the results of the analysis.

### FIELD OF THE INVENTION

The present invention relates generally to improved systems and techniques for promotional displays. More particularly, the invention relates to systems and techniques for capturing images of products as they are scanned and presenting displays of the scanned products in accordance with criteria for promotion of products.

### BACKGROUND OF THE INVENTION

Product promotions are an important aspect of retail sales. In store promotions are widely conducted and take many forms, all directed toward the goal of motivating the customer to make a purchase. Particularly in the in store environment, the most successful promotions are those that motivate a customer to make an immediate purchase. One important aspect of promotional activity is meeting the customer's immediate needs. Significant customer needs relating to product purchases are the assurance of the quality and value of the product, and providing a customer with such assurances is an important tool in motivating an immediate purchase.

### SUMMARY OF THE INVENTION

The present invention recognizes that customers frequently rely on the experiences and impressions of others in evaluating products and other potential purchases. Customers recognize that self interest is an important motivator for themselves and for other potential customers, so that observation by a potential customer of the actual purchase of a product by another customer may create a perception of the potential customer that the purchase of the product is in his or her interest. The observation by potential customers that significant numbers of others are purchasing a product will help to motivate purchases by these potential customers, because the potential customers will be reassured by the perception that others have viewed the purchase as beneficial to them.

To provide such an assurance, a system according to an aspect of the present invention captures images of items being purchased at the time they are purchased, and presents images in appropriate locations where they will catch the attention of other potential customers. For example, images of an item may be captured as the item is entered into a transaction, and the images may be presented using display monitors near shelves where the item is stocked. Various criteria may be used to determine which products are to be displayed as they are scanned. For example, a retailer typically enters into promotional agreements with vendors, and the display of items may be part of such promotional agreements. In an exemplary system according to an aspect of the present invention, a list of products selected for image display is maintained at a central server. A plurality of point of sale terminals communicates with the server. As purchase transactions are carried out, an image of each product being purchased is captured at an appropriate location, such as at presentation of the product at a bar code scanner. Identification information for the item being purchased is relayed to the server, which examines the list of products selected for image display. If the item is selected for image display, the image captured at the terminal is relayed to an appropriate display. Selection of displays for presentation of an image may be accomplished according to any of a number of different criteria. For example, images of products shelved in a particular location may be presented using displays in the vicinity of the location where the products are shelved. To take another example, more prominent displays may be used for presentation of images of specified products based on agreements with the vendors of the specified products. Further alternatives include the assignment of particular displays to point of sale terminals. Numerous additional alternatives exist.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a system for promotional display creation and presentation according to an aspect of the present invention;

FIG. 2 illustrates a retail location implementing a system according to an aspect of the present invention;

FIG. 3 illustrates a display presented according to an aspect of the present invention; and

FIG. 4 illustrates a process of promotional display creation and presentation according to an aspect of the present invention.

### DETAILED DESCRIPTION

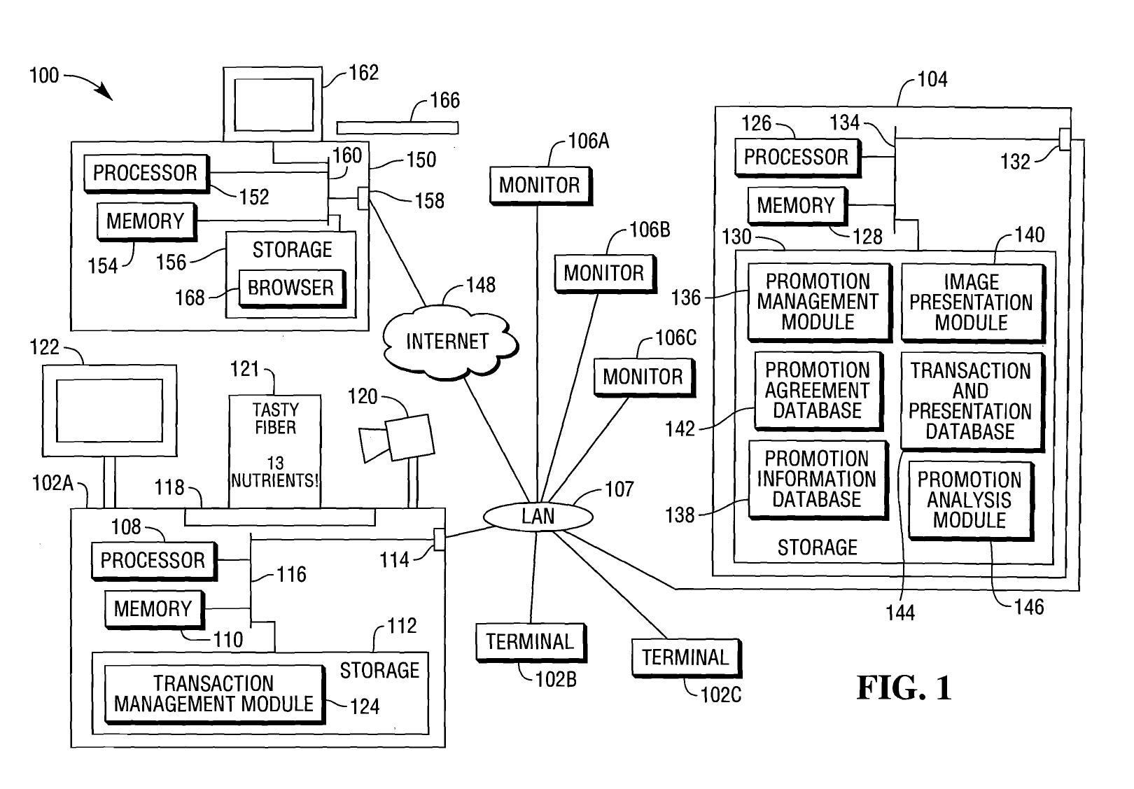

FIG. 1 illustrates a system 100 according to an aspect of the present invention. The system 100 includes a plurality of point of sale terminals 102A-102C, a central server 104, and a plurality of display monitors 106C-106C. The point of sale terminals 102A-102C may suitably communicate over a local area network 107. By way of example, the display monitors 106A-106E are shown here as also communicating over the network 107, but it will be recognized that numerous alternative mechanism exist for delivering information to and otherwise communicating with the monitors 106A-106E.

Further details of the terminals 102B and 102C are not illustrated here, but it will be recognized that they may be similar and may operate in a similar way to the terminal 102A. The point of sale terminal 102A includes a processor 108, memory 110, storage 112, and a network interface 114, communicating over a bus 116. The terminal 102A further includes a scanner/scale combination 118, and a camera 120 for capturing an image of a product being presented for entry into a purchase transaction. In the present example, the camera 120 is directed to capture an image of the product 121. The camera 120 may suitably placed and oriented so that it does not capture identifying features of a customer or employee presenting the product 121. As an alternative, however, a customer may choose to have his or her image accompanying a product, with this preference being stored, such as in association with a customer loyalty card record. A customer's image may be captured at the time of a product purchase, or alternatively a customer image may be taken and stored in a customer's loyalty card record and used under circumstances approved by the customer and by the management of the retailer. If a customer image captured at the time of purchased is used, visual analysis may be performed on the image to insure that the image presents a positive attitude about the product. For example, the customer image may be used only if it is determined to portray a cheerful attitude.

The terminal 102A further includes a display 122, which may suitably be a touch screen display. The terminal 102A operates under the control of a transaction management module 124, suitably implemented as software residing in the storage 112 and transferred to memory 110 as needed for execution by the processor 108. As each product is presented for entry into a transaction, the transaction management module 124 directs the camera 120 to capture an image of the product, and the image and other relevant information relating to the product are transmitted to the server 104.

The server 104 includes a processor 126, memory 128, storage 130, and network interface 132, communicating over a bus 134. The server 104 implements a promotion management module 136, which is suitably implemented as software residing in storage 130 and transferred to memory 128 as needed for execution by the processor 126. The promotion management module 136 has access to a promotion information database 138, storing promotional information for various products that are to be promoted based on agreements with vendors, the objectives of the retailer by or for which the system 100 is operated, or the like. One aspect of the promotional information that is stored is information used in making decisions relating to the display of product images that are captured as the products are presented for transactions. For each product sold by the retailer, the promotion information database 138 stores a record associated with the product, such as a product identifier, product descriptive information, and criteria for displaying product images. Criteria for displaying product images include criteria such as a product's participation or nonparticipation in various promotions involving the display of product images and criteria used in selecting displays for presentation of images of the product, including whether an entire monitor is to be dedicated to an image of the product, or whether the image is to share a monitor with images of other products. For example, the display area of a monitor may be segmented, for example, into halves or quarters, so that one product image is presented in each segment of the display area.

A product record for a product may also store one or more images of the product, captured as the product is scanned or otherwise entered into a transaction at various ones of the terminals 102A-102C. Depending on the particular configuration of the system 100, product images may be presented as they are captured, or may be held to allow for presentation at desired times. For example, a product image that prominently and clearly presents the product may be substituted for images captured during subsequent transactions in which the product image is blurred or otherwise unclear. A product record may also include associations with other related products, so that stored images of the related products can be retrieved and displayed in an appropriate sequence. Additional information might include the location of the product, so that a display of the product can include information directing shoppers to the location.

A product record may store additional information and images. For example, stored product images may include images illustrating the production or storage of the product, or a series of images relating to such production.

As the server 104 receives product information from transaction processing modules such as the transaction module 124 controlling the terminal 102A, the promotion management module 136 examines the information, using product identification information to retrieve an appropriate product record from the promotion information database 138. The promotion management module 136 examines the product record and determines whether and how to display the image captured by the terminal. If the product identification does not appear in the database 138, or if the product information stored in the database 138 indicates that no image is to be presented, the image is discarded.

If the product information stored in the database 138 indicates that the image is to be displayed, the promotion management module 136 invokes an image presentation module 140, which selects presentation parameters and prepares and directs a display image based on the stored information. The image presentation module 140 examines the promotion record for the product for information indicating which display or displays are to be chosen for presentation, and the position that is to be given to the image on the display or displays with which it is presented. For example, the promotion record for one product may indicate that the product image is to be presented on a monitor disposed near the shelves where the product is presented for sale, as one portion of a display presenting four products simultaneously, for a duration of 30 seconds. The promotion record for another product may indicate that the product is to be presented on a monitor disposed in a prominent location near the entrance of the store, to take up the entire display, and to remain until presentation of a different product using the same monitor is directed.

To take another example, the promotion record for another product, such as a soft drink, may indicate that the product is to take up a quarter of a display partitioned into four sections, and the image presentation module 140 may present images of products that may be purchased to accompany the soft drink in the remaining quarters of the display. To take a further example, the promotion record for a product may indicate that a product is to be presented in a prominent location, and the image presentation module 140 may indicate that the presentation of the product is to be sequenced with displays showing the location of the product and text directions to the product.

To take a further example, the promotion record for a product such as an article of organic meat may include images of the living conditions of the animals from which the meat is produced, and the promotion record may indicate that a presentation is to comprise a split screen display, with half of the display presenting a captured image of the item taken during a transaction, and the other half of the display presenting a sequence of images illustrating a humane and sanitary housing of animals used by the producer of the item.

The server 104 may suitably maintain a promotion agreement database 142, which stores promotion agreement information relating to various products and indicating which products are affected and how each product is affected. The server 104 may also maintain a transaction and presentation database 144, which includes information indicating how frequently each product is entered into a transaction, how and where images of each product are displayed, and additional information relating to product purchases and promotional displays of product images. The server 104 may implement a promotion analysis module 146, which examines information such as the information from the promotion agreement database 142 and the transaction and presentation database 144 and determines parameters for presentation of promotional images in light of the information. For example, changes in promotion agreements may add or eliminate products or change the prominence of the displays of products and the rate at which products are purchased may affect the duration that is to be given to displays of the product. The promotion analysis module 146 updates the promotion information database 138 based on the results of its examination and analysis, adding and deleting product records and modifying the specifications for display of images, as appropriate.

The promotion analysis module 146 may be used to generate parameters used to control the display of an image as product information is received at the server 104. In this embodiment, the promotion management module 136 receives the captured image and product information from a terminal such as the terminal 102A, retrieves information from the database 138, and passes the information received from the terminal and retrieved from the database to the promotion analysis module 146. The promotion analysis module 146 examines the databases 142 and 144 for information relating to the product and performs an analysis to compute parameters for the display of the image associated with the transaction under examination. Such a procedure allows for an immediate analysis of factors affecting a promotional display and the determination of display parameters based on the analysis, rather than basing the determination of display parameters on stored records that change only when a record is updated. Such analysis may also allow for the construction and arrangement of displays in any number of desired ways. For example, the promotion analysis module 146 may keep track of the rate of sale of various products, and such information may be used by the promotion management module 136 to use such information in choosing and constructing displays. For example, an increased rate of sale may act as a trigger for a more prominent display of a product, and may also trigger the selection of text calculated to create a sense of urgency among shoppers. For example, if a product promotion includes a substantial price reduction, a display may highlight the existence of a bargain and point to the response of other shoppers. To take another example, if a store is being visited by shoppers who are purchasing supplies for an emergency, such as a windstorm, special information may be provided for use by the promotion analysis module. For example, the identities of various useful supplies may be prominently displayed, and particularly if the store has abundant supplies or is restricting the number of units of each product that may be purchased, displays may be created emphasizing that sufficient supplies are available for everyone and presenting the number of units that are on hand and the hourly rate of sales.

In addition to presentation using local displays such as the monitors 106A-106C, presentation may also be accomplished remotely, for example, using the public Internet 148. The server 104 may communicate through the public Internet 148 with a plurality of user computers such as the computer 150. The computer 150 employs a processor 152, memory storage 154, storage 156, and network interface 158, communicating over a bus 160. The computer 150 also employs a monitor 164 and keyboard 166, and implements a browser 168 for presenting web pages. The server 104 may support online shopping capabilities and may present information in the form of web pages delivered to terminals such as the terminal 150. Appropriate images may be selected, and displays may be prepared for delivery to online shoppers, providing online shoppers with information and images relating to products on demand by local shoppers. The server 104 may also receive and compile sales information from online transactions, and may use this information to refine sales information that may be used to determine current sales trends and popularity of products. Such information may be employed to determine the selection, formatting, and prominence of product images that are displayed, both locally and to online shoppers.

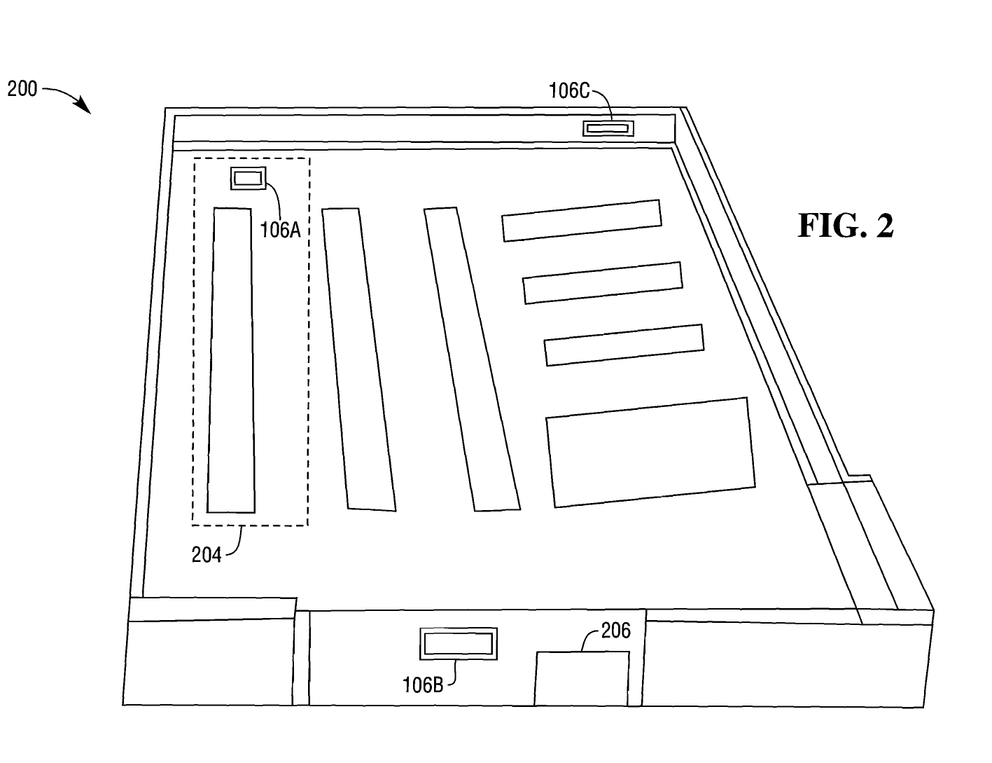

FIG. 2 illustrates an exemplary retail environment 200 in which the system 100 is used. The monitors 106A-106C are visible, and are used to display captured images of products based on marketing agreements with suppliers of the products and other criteria used in making decisions relating to promotion of the products. The monitor 106A is disposed near the shelving area 204, and may typically be expected to be used for images of items shelved in the area 204. The monitor 106B is disposed at a prominent location near the entrance 206, and may be expected to be used for images of items to be given special prominence, such as items for which a special agreement exists with the vendor or items which are particularly profitable to the retailer. The monitor 106C is disposed at a prominent location near the rear of the location 200, and may be expected to be used for images of items which are shelved nearby and which are to be given special prominence.

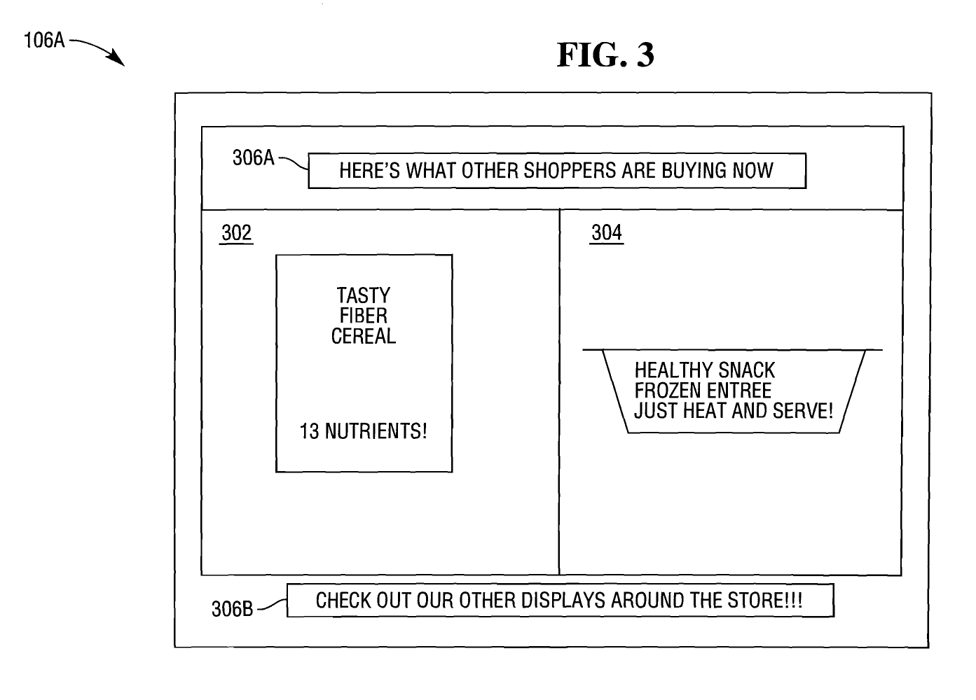

FIG. 3 illustrates a closer view of the monitor 106A. The monitor 106A presents display area 302 showing a captured image of the product 121, and display area 304, showing a captured image of another product whose image is captured at another terminal, along with promotional text 306A and 306B, calling attention to the fact that the products are currently being purchased by other shoppers and inviting shoppers to view other displays.

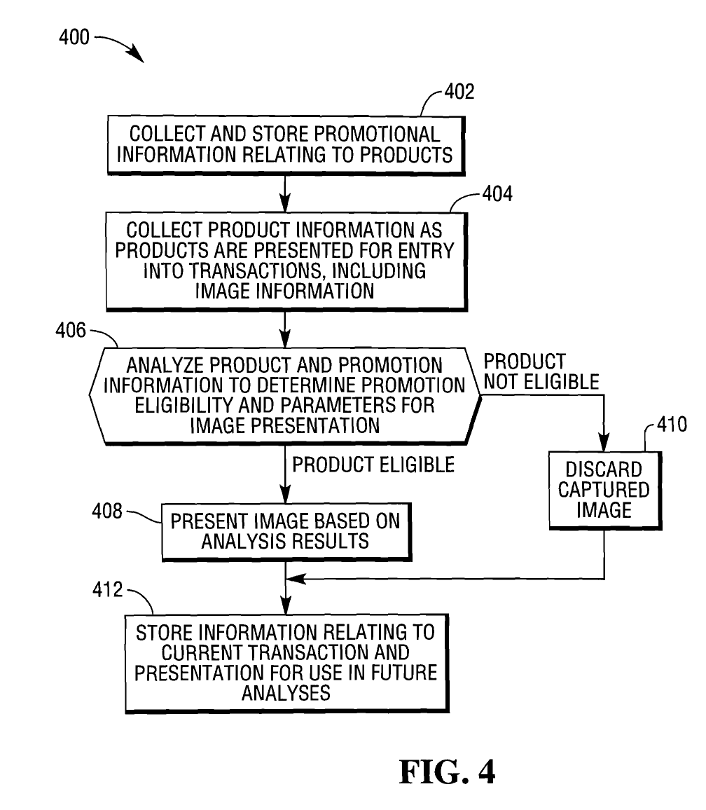

FIG. 4 illustrates the steps of a process 400 according to an aspect of the present invention. The process may suitably be performed using a system such as the system 100 of FIG. 1. At step 402, promotional information is collected for a plurality of products sold by a retailer. The promotional information includes information relating to factors to be taken into account in determining when and how captured images of products are to be displayed, and may also include stored images of the product itself and images to be presented in association with the product. Examples of factors to be taken into account may include promotional agreements with vendors of products and considerations of the retailer by or for whom the process 400 is performed, such as profitability of products, or a need to reduce inventories of the products. Additional examples of factors that may be taken into account may include popularity of the product, measured by sales over a specified period, such as the preceding week or month, by customer popularity ratings and comments, or by sales rate at the time the image of a product is captured. For example, products exhibiting a high sales rate at the moment may be selected for image presentation over products exhibiting a lower sales rate. The promotion information is stored in a computer accessible memory device, such as long term storage of a central data processing server, as it is collected.

At step 404, as products are presented for purchase at one or more point of sale terminals, product information is collected. The product information includes a product identifier and a captured image of the product. At step 406, the product information is analyzed to determine whether the product is eligible for promotional display of the captured image, and the format and location of presentation. Factors influencing decisions relating to the presentation of an image and the format and location of presentation of an image may include factors such as the presence of discounts for the product, the presence of other, related products that may be presented along with the product involved in the transaction, acceptance of a customer purchasing the product of the display of his or her image, the desirability of presenting images illustrating the production of the product, and numerous other factors relating to the information that is desired to be presented. Additional factors may include information indicating current and historical sales rates of the product, current promotions for the product or a group of products of which the product in question is a member, and other relevant factors.

The analysis may suitably take into account stored information, as well as information relating to the current sale of the product. For example, if a display monitor is dedicated to a point of sale terminal, information identifying the point of sale terminal at which the transaction is being conducted will be used to select the monitor for presentation. To take another example, if a product is currently exhibiting a high rate of sale, displays of the product may be presented at a higher frequency than ordinarily, or given more prominence than ordinarily.

If the product is eligible for promotional display, the process proceeds to step 408, and a display is prepared and presented according to the analysis. The process then proceeds to step 412. If the product is not eligible for image presentation, the process skips to step 410 and the image is discarded. The process then proceeds to step 412. At step 412, information relating to the current transaction, the decision made relating to presentation of the captured image, and the presentation of the image is stored for later use in making decisions.

While the present invention is disclosed in the context of a presently preferred embodiment, it will be recognized that a wide variety of implementations may be employed by persons of ordinary skill in the art consistent with the above discussion and the claims which follow below.

I claim:

1. A server for managing presentation of promotional displays including images of products presented for entry into transactions, comprising:
memory for storing collected information relating to product promotions relating to conditions governing selection and presentation of promotional displays including images of products presented for entry into transactions;
a communication interface for receiving product information as products are presented for entry into transactions; and
a processor for performing analysis of the product information and the promotional information to select products for which promotional displays are to be presented and for directing construction and presentation of one or more promotional displays including images of the selected products based on the analysis.

2. The server of claim 1, wherein the product information for one or more products presented for entry into transactions includes captured images of the one or more products taken as the products are presented, and wherein one or more of the promotional displays includes a captured image of a product representing the product as it is presented for entry into a transaction.

3. The server of claim 1, wherein analyzing the promotional information takes into account the existence and terms of promotional agreements between a retailer and a vendor relating to the products being presented for entry into transactions.

4. The server of claim 1, wherein the processor directs presentation of captured images of a product in more or less prominent locations based on the terms of a promotional agreement between the retailer and the vendor relating to the product.

5. The server of claim 2, wherein the processor updates the promotional information based on information relating to sales transactions for products and presentation of captured images of products as the sales transactions and presentations take place.

6. The server of claim 5, wherein the analysis of the promotional information and product information includes monitoring current sales rates of different products and wherein the processor is operative to assign higher priority for display images featuring products exhibiting a higher current sales rate.

4. The server of claim 6, wherein the processor is operative to direct the inclusion of display text indicating product rates of sales and encouraging product purchase in display images assigned a higher priority due to a high sales rate for products.

8. The server of claim 1, wherein the analysis of the product information and the promotional information takes into account information relating to the popularity of each product being presented for entry into a transaction as measured by sales transactions involving the product.

9. The server of claim 1, wherein the processor is operative to analyze product information and promotional information for a first product entered into a transaction, wherein the promotional information for the first product identifies one or more related products that are frequently consumed in association with the first product, and wherein the processor is operative to direct presentation of images of the one or more related products in association with an image of the first product.

10. The server of claim 1, wherein promotional information for one or more products includes one or more images relating to the production of the one or more products, and wherein the processor is operative to direct presentation of images of each of the one or more products in association with the images relating to its production.

11. The server of claim 1, wherein the communication interface receives information relating to local transactions conducted at a retail establishment and online transactions conducted over the Internet, and wherein the processor is operative to construct one or more displays for presentation to remote terminals used to conduct online transactions over the Internet.

12. A method of managing promotional presentation of a captured image of a product presented for entry into a transaction, comprising the steps of:
upon presentation of a product for entry into a transaction at a point of sale terminal, capturing an image of the product;
retrieving promotional information relating to the product from a computer accessible memory;
analyzing the promotional information to identify conditions indicating the eligibility of the product for promotional display and determine parameters governing the promotional display; and
controlling a processor to direct presentation of a promotional display including the captured image based on the analysis.

13. The method of claim 12, wherein analyzing the promotional information includes identifying promotional agreements between a retailer and a vendor relating to the product and determining the eligibility of the product for promotional display and the parameters governing the display based on the terms of the agreements;

14. The method of claim 12, wherein determining the parameters governing the display includes assigning a greater or lesser prominence to the promotional display for the product.

15. The method of claim 12, wherein determining the parameters governing the display includes identifying additional products related to the product presented for entry into the transaction and selecting one or more of the additional products for inclusion in the display.

16. The method of claim 12, wherein determining the parameters governing the display includes selecting one or more images relating to the production of the product for inclusion in the display.

17. The method of claim 12, further comprising a step of controlling the processor to update the promotional information based on information relating to sales transactions for products and presentation of captured images of products as the sales transactions and presentations take place.

18. The method of claim 17, wherein identifying conditions indicating eligibility of the product for promotional display includes assigning a higher priority to the product if it exhibits a high current sales rate.

19. The method of claim 18, wherein determining the parameters governing the display includes selecting promotional text indicating a current sales rate and encouraging purchase for the product if it exhibits a high current sales rate.

20. The method of claim 12, wherein the analysis of the product information and the promotional information takes into account information relating to the popularity of each product being presented for entry into a transaction as measured by current sales transactions involving the product.
